(19) United States
(12) Patent Application Publication
(10) Pub. No.: US 2013/0035033 A1
(43) Pub. Date: Feb. 7, 2013

(54) Relay Nodes

(71) Applicants: Henning Sanneck, Munchen (DE); Peter Szilagyi, Debrecen (HU); Lars Christoph Schmelz, Haar (DE)

(72) Inventors: Henning Sanneck, Munchen (DE); Peter Szilagyi, Debrecen (HU); Lars Christoph Schmelz, Haar (DE)

(21) Appl. No.: 13/634,259

(22) PCT Filed: Mar. 15, 2010
(86) PCT No.: PCT/EP10/53247

§ 371 Date: Sep. 21, 2012

(51) Int. Cl. H04B 17/02; H04B 7/14

(52) U.S. Cl. 455/9; 455/7

(57) ABSTRACT

A method of establishing a relay connection between a relay node and a neighbouring base station includes the steps of: changing the mode of operation of a base station so that it is capable of operating as a relay node; and establishing an in-band wireless backhaul relay link between the base station operating as a relay node and the neighbouring base station.

This invention relates to relay nodes. It is particularly, but not exclusively, related to mobile radio network base stations (BS) configured to act as relay nodes.

Relay nodes are mobile network transmit/receive devices offering service to mobile terminals which connect to a radio network via an in-band wireless backhaul link instead of using a dedicated wired or wireless backhaul link, such as a microwave backhaul link. In-band relaying means that the same radio resources are used both by relays and by customer user equipment (UE) such as mobile terminals. In-band wireless links are in contrast to out-band wireless links such as dedicated microwave wireless backhaul links and other links such as wired links.

The purpose of using relay nodes is to provide coverage extension to regions of high shadowing or locations where dedicated backhaul links are not deployed, in order to maintain a good cost versus performance trade-off. Relay nodes can also be used to enhance capacity.

Relay nodes have been standardised for WiMAX (Worldwide Interoperability for Microwave Access) networks. Relay nodes for LTE (Long Term Evolution) networks are currently being standardised.

In LTE networks, relaying functionality is provided by Relay Nodes (RNs). An RN connects to a base station, an enhanced node B (eNodeB), which is referred to as a Donor eNodeB (DeNB) for that particular RN. Communication between the RN and the network is performed via the DeNB. A radio link between the RN and the DeNB is called a relay link. Mobile terminals can connect either directly to an eNodeB or to a RN, and both connection types are called access links.

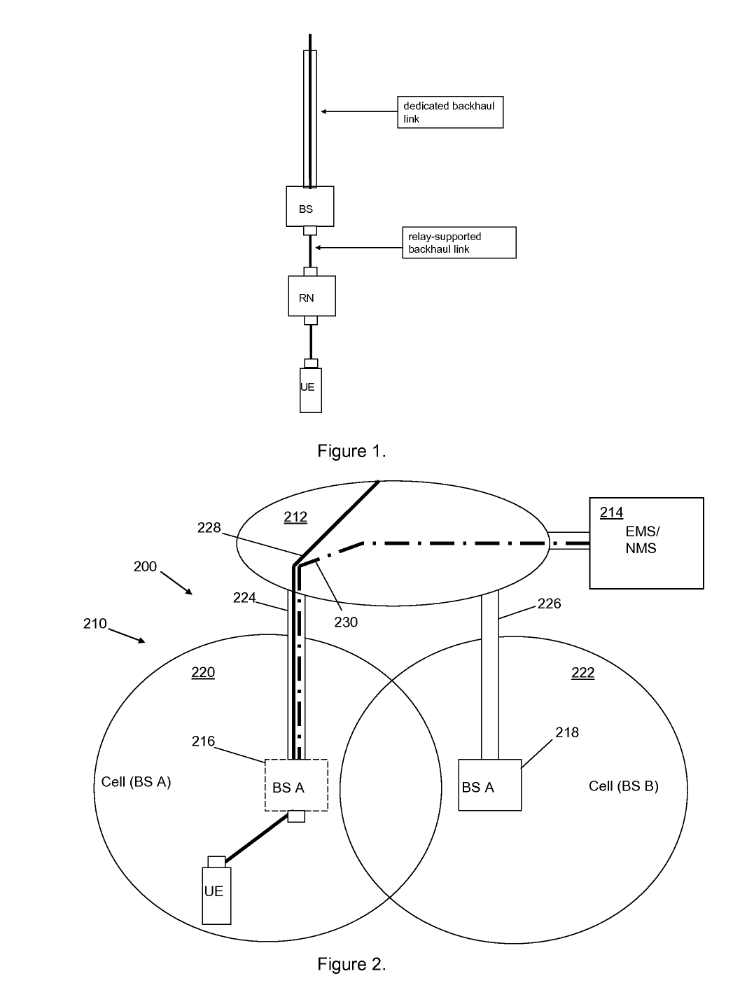

Relay nodes are capable of providing coverage extension in a mobile network at a lower hierarchical level than a node comprising a base station. FIG. 1 shows a RN relaying user traffic between a mobile terminal (UE) and a base station.

FIG. 2 shows a mobile network 200 according to the invention. The network 200 comprises a radio access network (RAN) 210, a core network 212, and an operation, administration, and maintenance (OAM) part 214. In this Figure, the OAM part 214 is identified by the term “EMS/NMS” (Element Management System/Network Management System). An EMS and an NMS are actually sub-parts of the OAM part 214. The RAN 210 comprises a number of base stations and other network elements. Although only base stations BS A 216 and BS B 218 are shown, it will be understood that the network comprises many more base stations. BS A 216 provides radio access to mobile terminals in a cell 220 and BS B 218 provides radio access to mobile terminals in a cell 222. In this figure, only one mobile terminal is shown, that is the mobile terminal in the cell 220.

Although FIG. 2 appears to show a strict division between the RAN 210 and the core network 212, it is common, for example in LTE systems, for certain RAN-type functionalities to exist in the core network.

The core network 212 provides mobility management, session management, and transport services for user data and also carries out related control tasks. Accordingly, the core network controls the functioning of the base stations BS A 216 and BS B 218. In addition to the functioning of the BS A 216 and BS B 218 being controlled by the core network 212, the OAM part 214 operates to control their configuration and re-configuration, and to manage faults which can occur in the base stations. The base stations BS A 216 and BS B 218 are connected to the core network 212 (or to relevant parts of a RAN depending on the implementation) by means of a backhaul link A 224 and a backhaul link B 226. In relation to each base station, two connections are shown, each representing a flow of data. In a user data connection, user data is conveyed between a base station and the core network 212 (and may also be conveyed beyond the core network 212), and in an OAM data connection, OAM data is conveyed between a base station and the OAM part 214. This OAM data may include messages relating to the configuration of base stations, alarms, updates, notifications, and commands. As can be seen in FIG. 2, in respect of the base station BS A, the user data connection is indicated by numeral 228 and the OAM data connection is indicated by numeral 230. The user and OAM data connections of the base station BS B are not shown in the Figures.

Problems can arise in the operation of a network 200. Usually, base stations connect to the core network (and via the core network to the OAM system) using wired links or a dedicated microwave link. However, these dedicated backhauls can either be missing entirely (case 1) at some locations, or they can fail (case 2).

Referring firstly to case 1, it can be difficult and expensive to install dedicated backhaul links for base stations, for example in rural environments. Therefore, installing a base station might be very straightforward but the lack of an available dedicated backhaul link may be an obstacle to it going into operation. This may result in missing coverage or capacity for an area.

Referring now to case 2, if a dedicated backhaul link is down, services provided by the base station may be interrupted. Although mobile terminals served by the base stations can be handed over to other adjacent base stations if they are available, this could impair overall coverage. Although there may be OAM functions available which could be used to put a base station back into service, these may not be available due to the unavailability of an OAM connection over the dedicated backhaul link. In a worst case, a technician may have to visit the base station to perform OAM operations and/or put it back into service. Therefore, if other ways of solving the problem are not available, it may be necessary to re-configure radio settings of neighbouring cells to maintain the necessary coverage.

In another case, there may be an end-to-end connectivity problem. There may be connectivity problems occurring somewhere on the end-to-end connectivity path other than on a dedicated backhaul link. For example, the OAM connection between a base station and the OAM part 214 may be down even if connectivity for user traffic is up and running.

According to a first aspect of the invention there is provided a method of establishing a relay connection between a relay node and a neighbouring base station, comprising the steps of:

activating relay capability of a base station so that it operates as a relay node; and

establishing an in-band wireless backhaul relay link between the base station operating as a relay node and the neighbouring base station.

Preferably, the base station operating as a relay node operates in this way with respect to a network. Whilst in this mode, the base station may continue operating as a base station which respect to mobile terminals.

Preferably, once a dedicated backhaul link is available via which the base station capable of operating as a relay node is able to communicate with a network, communication is switched over from the in-band wireless backhaul relay link to the dedicated backhaul link and the in-band wireless backhaul relay link is disabled.

Preferably, the method is applied in a communications network. It may be a mobile communications network. The network may comprise a radio access network, a core network, and an OAM part.

Preferably, the base station capable of operating as a relay node is pre-configured to enable it to operate as a relay node. Preferably, the base station capable of operating as a relay node is pre-configured with information about another base station through which it is permitted to connect to via the in-band wireless backhaul relay link. A number of other base stations may be identified. In an alternative embodiment, the base station is pre-configured to be capable of setting up an in-band wireless backhaul relay link but is not provided with information about other base stations with which it can establish a relay-type connection. Whether or not the base station is provided with such information, when the base station capable of operating as a relay node comes to choosing a DeNB, it may use a cell selection procedure to select a neighbouring base station as the DeNB which appears to offer the best connectivity.

In one embodiment of the invention, the relay connection is established following the detection of a communication problem. There may be a determination made that an in-band wireless backhaul relay link is to be used. This determination may be made within the base station capable of operating as a relay node, within a neighbouring base station, within the core network, or within the OAM part.

In another embodiment of the invention, the base station capable of operating as a relay node is pre-configured to enable an in-band wireless backhaul relay link to be used during a network installation/rollout.

In response to the base station capable of operating as a relay node receiving the determination, the mode of the base station may be changed to it being a relay node.

Preferably, the in-band wireless backhaul relay link is established by the base station capable of operating as a relay node carrying out an attach procedure corresponding to that carried out by UEs towards the neighbouring base station. The in-band wireless backhaul relay link may be established by at least one of the base stations allocating its radio resources between a part assigned to establish/maintain access links with mobile terminals and a part assigned to the relay-type link. This base station may then signal to the other base station information relating to this allocation. The other base station may configure itself accordingly. The base station which signals the other base station may also configure itself according to this allocation.

The base station may have a user data connection to convey user data between the base station and the core network. The base station may have an OAM data connection to convey OAM data between the base station and the OAM part.

In a case in which a dedicated backhaul link fails, a connection from the base station capable of operating as a relay node to the core network may be established via the in-band wireless backhaul relay link to the neighbouring base station and then via a backhaul link between that base station and the core network. The user data connection and the OAM data connection may be transmitted via this connection.

In another failure case, there may be disruption only to one of the user data connection and the OAM data connection in which case, one of these connections may be routed via the in-band wireless backhaul relay link to the neighbouring base station and then via a backhaul link between that base station and the core network, and the other of these connections may be routed via the dedicated backhaul link of the base station capable of operating as a relay node. In this case, the base station capable of operating as a relay node concurrently acts as a base station as well as a relay and concurrently uses both its dedicated backhaul link and the in-band wireless backhaul relay link.

Failure may be detected in the OAM part. The OAM part may then notify the base station capable of operating as a relay node. Such a notification may be provided via the neighbouring base station. The notification may trigger the base station capable of operating as a relay node to make a relay-type connection to the neighbouring base station.

In one embodiment of the invention, the neighbouring base station is able to re-configure itself by modifying its cell coverage so that it covers the location of the base station capable of operating as a relay node. Alternatively or additionally, the base station capable of operating as a relay node is able to re-configure itself by modifying its cell coverage so that it covers the location of the neighbouring base station. This modification may involve an increase in cell size.

In another aspect of the invention, the base station capable of operating as a relay node has an established in-band wireless backhaul relay link in operation while its backhaul link is still fully functional. Accordingly, the base station has a dual-operation mode in which it is operating as a relay node and is also operating as a base station in a normal manner. In such a case, a failure notification could be directly communicated from to the base station from a neighbouring base station via the already established in-band wireless backhaul relay link. In this case, the in-band wireless backhaul relay link may be useable for signaling but has a quality and/or bandwidth which is not good and/or high enough to serve as in-band wireless backhaul relay link for user traffic. When the failure notification is received by the base station capable of operating as a relay node, it then re-configures itself to improve the characteristics of the in-band wireless backhaul relay link.

Preferably, the method is provided in an LTE mobile communications system.

Preferably, the neighbouring base station is a donor eNodeB (DeNB). In one embodiment of the invention, the DeNB is used to multiplex traffic from multiple neighbouring base stations, capable of operating as relay nodes, to a single backhaul link.

According to a second aspect of the invention there is provided a base station comprising:

a relay capability which enables the base station to operate as a relay node; and

a connectivity element capable of establishing an in-band wireless backhaul relay link a between the base station operating as a relay node and a neighbouring base station.

According to a third aspect of the invention there is provided a communication system comprising an access network having a plurality of base stations, wherein at least one base station comprises:

a relay capability which enables the base station to operate as a relay node; and

a connectivity element capable of establishing an in-band wireless backhaul relay link a between the base station operating as a relay node and a neighbouring base station

According to a fourth aspect of the invention there is provided a computer program product comprising software code that when executed on a computing system performs a method of establishing a relay connection between a relay node and a neighbouring base station, the method comprising the steps of:

activating relay capability of a base station so that it operates as a relay node; and

establishing an in-band wireless backhaul relay link between the base station operating as a relay node and the neighbouring base station.

Preferably, the computer program product has executable code portions which are capable of carrying out the steps of the method.

Preferably, the computer program product is stored on a computer-readable medium.

An embodiment of the invention will now be described, by way of example only, with reference to the accompanying drawings in which:

FIG. 1 shows a network configuration;

FIG. 2 shows a network;

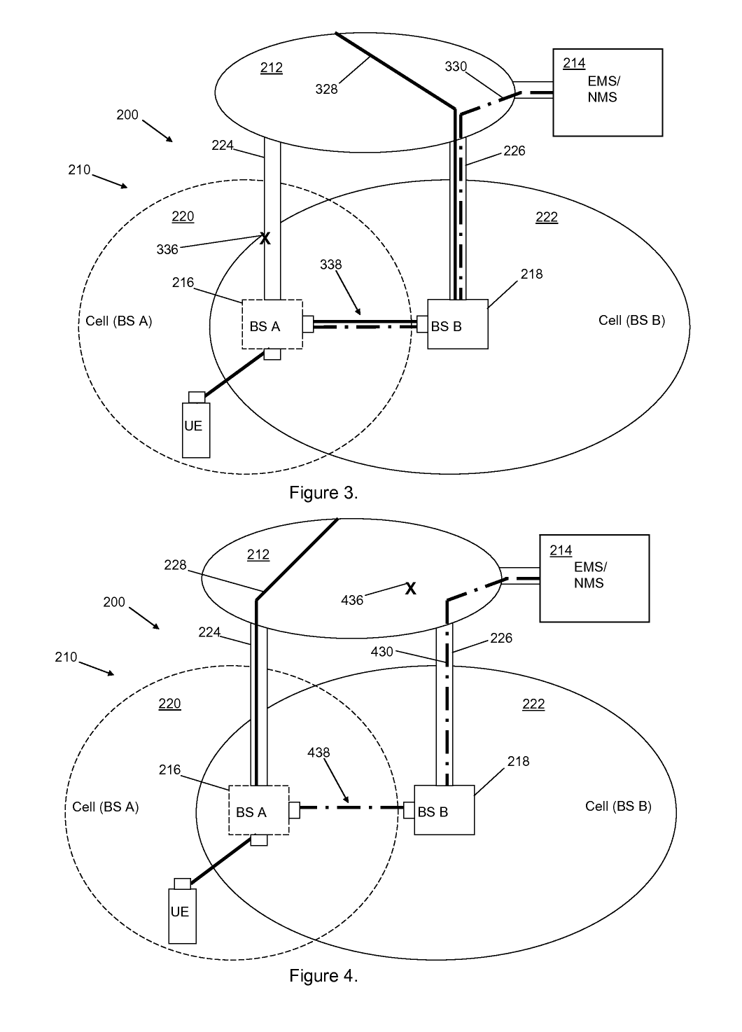

FIG. 3 shows the network according to FIG. 2 in another state; and

FIG. 4 shows the network according to FIG. 2 in yet another state.

The invention will now be described with reference to FIG. 2. Although this Figure has been used to describe the prior art, since the invention provides additional functionality to a network of the type shown in FIG. 2, this Figure is used to describe the invention for the sake of convenience.

In this embodiment of the invention, it is described in relation to its application in an LTE mobile communications system.

The invention provides additional functionality in the OAM part 214 to control the way in which the base stations operate and also additional functionality present in the base stations to change their mode of operation. In particular, the OAM part 214 is able to use its additional functionality, in certain defined circumstances, to change the mode of operation of base stations so that they are no longer operating as base stations with respect to network elements at a higher hierarchical level than their own, but are instead operating as relay nodes and are communicating with network elements (base stations) at the same hierarchical level. This enables the network 200 to deal with situations in which a communication problem or situation prevents direct communication between a base station and higher hierarchical levels of the network 200 which leaves the base station isolated. In such a case, communication is established between the isolated base station and another base station via which the higher hierarchical levels may be reached. In this way, the isolated base station undergoes a mode change to become a relay node which is capable of relaying communications between mobile terminals served by the isolated base station and the higher hierarchical levels.

In this embodiment of the invention, applied to an LTE mobile communications system, in their normal mode, base stations communicate with network elements in a core network which are at a higher hierarchical level than their own and if their mode is changed, they operate with respect to base stations which are at the same hierarchical level.

It will be understood that if a network element in the form of a base station has had its mode changed from base station to relay node, then as far as network elements at the same or higher hierarchical level are concerned, it may be considered that the network element in its operation as a relay node is operating at a lower hierarchical level than it was when it was operating as a base station. Accordingly, in terms of its interaction with a base station, it is communicating with a network element at a higher hierarchical level. However, since it is still providing access links to mobile terminals, then as far as they are concerned, the hierarchical level of the base station does not appear to have changed.

A system according to the invention uses an in-band wireless backhaul relay link to connect isolated base stations to the core network 212 and the OAM part 214. This can be configured, enabled, and disabled as follows:

1. Pre-configuration of the in-band wireless backhaul relay link.

At a point in time before the in-band wireless backhaul relay link is enabled, it needs to be configured. Accordingly, a base station is configured with settings which enable it to:

a) respond to a determination that necessary conditions prevail for the in-band wireless backhaul relay link to be put into use;

b) identify a base station or base stations towards which it is to make a relay-type connection ; and

c) make the relay-type connection to a suitable base station.

The base station may also be provided with settings which enable it to accept relay-type connections from other base stations acting as relays. These settings may identify particular base stations from which attempts to set up relay-type connections are to be accepted and then subsequently set up.

As a result of the pre-configuration, the in-band wireless backhaul relay link is available to be set up but is not yet in use. Furthermore, since the in-band wireless backhaul relay link has been pre-configured, in a case in which there is a connection failure, the suitably configured base station is able to switch over seamlessly from communicating with the core network via its backhaul link to communicating, as a relay node, with another base station. However, use of in-band wireless backhaul relay links is not restricted solely to situations in which there is connection failure. In the case of the base station newly being installed as part of a network, it may have been pre-configured so that it is able to operate without the need to even use a conventional backhaul link and might communicate, right from its installation, via an in-band wireless backhaul relay link.

In the foregoing, the selection of a base station, presumably an adjacent base station, towards which the relay-type connection is made is predetermined by the identification of suitable adjacent base stations during pre-configuration. In an alternative embodiment of the invention, although a particular base station is pre-configured to be capable of setting up an in-band wireless backhaul relay link, this does not involve the identification of suitable adjacent base stations. Instead, the particular base station contains an instruction that in the event of it needing to operate in relay mode and thus to establish a relay-type connection towards another base station, it is to do this by carrying out a cell selection procedure, for example by selecting a base station in a cell which indicates to the particular base station that it offers the best connectivity. This would typically be the strongest signal as long as other criteria are met, such as stability of the signal. This may be configured by allowing the particular base station to operate in a mode in which it monitors adjacent base stations and, if the need to establish a relay-type connection arises, to make a selection of a base station towards which the relay-type connection will be established. This is akin to an idle mobile terminal camping in an adjacent cell. However, in a preferred variant of this embodiment, carrying out cell measurements for the purposes of cell selection is done only after the need arises for there to be an in-band wireless backhaul relay link, whether this is caused by a connection failure or the particular base station being installed in a network.

At the end of this step, the pre-configured base station is provided with the means to establish an in-band wireless backhaul relay link to an adjacent base station when the need arises.

2. Switch-over to and enabling of the in-band wireless backhaul relay link.

A determination is made that an in-band wireless backhaul relay link is to be used. As will be seen later, this determination can be made at a number of points of the network, for example within a base station, within the core network 212, or within the OAM part 214. This can be the case if, for example, it is detected that a “normal” dedicated backhaul link providing connectivity between the base station and the RAN/core network is down. This can be done by employing the available procedures in a base station to detect that a link is down and internally generating an appropriate alarm. The alarm may trigger the base station to put the in-band wireless backhaul relay link (already pre-configured in step 1.) into use.

Alternatively, as referred to in the foregoing, base stations may have been pre-configured to enable an in-band wireless backhaul relay link to be used during a network installation/rollout. In this case, base stations are explicitly configured to use the in-band wireless backhaul relay link rather than a dedicated backhaul link (which may be provided later or even). In a case in which a dedicated backhaul link is not to be made available, the in-band wireless backhaul link may be permanent. In any event, as part of such an installation, a determination is made that an in-band wireless backhaul relay link is to be used.

In the following, setting up of the relay link is described. Any generally known type of set-up procedure may be used, for example allocating radio resources and establishing signaling connections between the two base stations and between the base station connecting via the relay link and the OAM system. It is preferred to set up the relay link only when the need for a relay link arises. Postponing relay link set-up has the advantage of delaying use of resource allocation until necessary.

Setting up the relay link can be carried out using any convenient procedure. For example in an LTE system, the Radio Resource Control (RRC) Protocol may be used in which an RN initiates a connection to a DeNB by acting as a user equipment (UE).

More specifically, the base station BS A carries out a UE attach procedure with the base station BS B. Once this has been done, a radio channel is established between the base station BS A and the base station BS B. In addition, a GTP (GPRS tunneling protocol) tunnel may have been established between the base station BS B and the core network (although in some embodiments this may not be necessary). The base station BS A can then signal a request to the base station BS B that a relay-type link is to be set up.

Accordingly, the base station BS B accepts the base station BS A as a relay node and the base stations then cooperate to establish the relay-type link. This link has a considerably larger bandwidth than the channel established as a result of the UE attach procedure because it needs to be large enough to cope with the whole of the traffic handled by the base station BS A. At this point, the base station BS B, instructed by the base station BS A to establish the relay-type link, allocates its radio resources. In one embodiment of the invention, the radio resource block of the base station BS B splits the frequency range over which it operates into two parts: a frequency sub-range assigned to establish/maintain access links with mobile terminals served by the base station BS B and a frequency sub-range assigned to the relay link. The base station BS B signals to the base station BS A an indication of the way in which the radio resources are being split to the base station BS A and the base station BS A configures itself correspondingly. The base station BS B acts as a master during establishment of the relay-type link. It will be understood that the radio resources do not necessarily have to be split in the frequency domain and a split in any other domain may be applied.

In addition, in response to the determination, the mode of the base station is changed to it being a relay node.

3. Switch-over to regular backhaul link and disabling of the in-band wireless backhaul relay link.

At a later point, it is desired for the base station operating in relay node mode to use a “normal” dedicated backhaul link. This may be in response to an indication that the “normal” dedicated backhaul link has been restored and is now available for use or that, in the case of a new installation, a new “normal” dedicated backhaul link has been provided for the base station to use. Accordingly, the mode of the base station is switched to it being a base station rather than a relay node and the connectivity as a relay node to one or more adjacent base stations is shut down.

The foregoing will now be described with reference to FIGS. 2, 3, and 4 showing different states of the same network. FIG. 2 shows normal operation of the base station BS A, FIG. 3 shows the situation after switch-over to and enabling of the in-band wireless backhaul relay link using the method described in the foregoing, and FIG. 4 shows the network 200 of FIG. 2 after it has responded to an end-to-end connectivity problem.

FIG. 2 shows normal operation of the base stations BS A and

BS B. As described in the foregoing, each base station is able to transfer user data via the user data connection between itself and the core network 212 and OAM data via the OAM data connection between itself and the OAM part 214. Although the configuration of FIG. 2 corresponds with the prior art, in this case the base stations BS A and BS B have been pre-configured to establish a relay-type connection between themselves in the event of there being a determination that this is required. Accordingly, FIG. 2 shows the network 200 in a state at which step 1 of the method according to the invention has been applied.

FIG. 3 shows the network 200 of FIG. 2 after it has responded to a failure in a “normal” dedicated backhaul link, in this case the backhaul link A 224. The failure is indicated by numeral 336. Prior to the state shown in FIG. 3, this failure 336 is determined (step 2) and then the base station BS A initiates relay-type connectivity towards the base station BS B and an in-band wireless backhaul relay link 338 is established. Once this is done, a user data connection 328 and an OAM data connection 330 of the base station BS A are re-routed via the base station B to the RAN/core network 212 firstly over the in-band wireless backhaul relay link 338 and secondly over the backhaul link B 226. In addition, the mode of the base station A is changed from “base station” to “relay node” (at least in terms of how it is perceived by other base stations and the network in general). As a result, a switch over has been carried out and the network 200 is put into the state shown in FIG. 3.

In order to deal with the failure of the dedicated backhaul link, the base station BS A has switched over to the in in-band wireless backhaul relay link. Therefore, it is possible to put a base station back into service in a relatively straightforward way which requires considerably less effort than would otherwise be required, for example by re-configurating the radio interface of neighbouring cells to cover a gap in the network.

FIG. 4 shows the network 200 of FIG. 2 after it has responded to an end-to-end connectivity problem. In this case, the dedicated backhaul link of base station BS A 224 is working, but there is a failure somewhere in the network other than in a dedicated backhaul link. This failure is indicated by numeral 436. In this particular failure case, there is a problem in the core network 212 which disrupts communication between the BS A 224 and the OAM part 214 (the OAM connection 230) but does not disrupt communication of user traffic (the user data connection 228). Therefore, it will be understood that the dedicated backhaul link is still working.

Prior to the state shown in FIG. 4, this failure 436 is determined (according to step 2 in the foregoing) and then the base station BS A initiates relay-type connectivity towards the base station BS B and an in-band wireless backhaul relay link 438 is established. Once this is done, the OAM data connection 430 of the base station A is re-routed via the base station B to the OAM part 214 firstly over the in-band wireless backhaul relay link 438 and secondly over the backhaul link B 226. Therefore, the OAM data connection 230 can be restored automatically, without the interaction of the OAM operator, by using a redundant relay-based OAM link. This may be convenient if the access permissions necessary to solve a problem in the core network are restricted and so the OAM part 214 can operate to work around the problem while personnel with the relevant access permissions are located and set to work solving the underlying problem in the core network.

However, because the user data connection 228 has not been disrupted, the connection is not re-routed and instead is maintained over the backhaul link A 224. In addition, the mode of the base station A is changed from “base station” to “relay node” (at least in terms of how it is perceived by other base stations and the network in general). It will be noted in this case that the base station concurrently acts as a regular base station as well as a relay and concurrently uses both the dedicated backhaul link and the in-band wireless backhaul relay link to circumvent a failure in the core network. As a result, the network 200 is put into the state shown in FIG. 4.

Therefore, it can be seen that in order to circumvent the failure point 436, OAM-related traffic is re-routed via the in-band wireless backhaul relay link.

Although FIG. 4 has been described in relation to the OAM data connection 230 being re-routed via the in-band wireless backhaul relay link 438 and the user data connection 228 being maintained over the backhaul link A 224, it is possible for both connections to be re-routed via the in-band wireless backhaul relay link 438 if the core network failure has disrupted both the OAM data connection 230 and the user data connection 228, or for the sake of convenience if only one connection is disrupted but it is preferred for both connections to be established over a common backhaul link.

In addition to the embodiments described in the foregoing, the invention may be applied in a situation in which a base station is being installed without an available dedicated backhaul link and can be switched on immediately after the installation

Thus, it is not required to delay the installation, or to carry out an additional site visit involving the configuration of the dedicated backhaul link. This is particularly useful in a case in which for some reason it is not possible to install a microwave backhaul link and the practical alternative would be to install a wired backhaul link which would need a significant amount of time and would incur considerable cost.

Accordingly, the roll-out for a large number of base stations may be made independent of the availability of dedicated backhaul links. This can result in cost savings and increased operator revenue.

In any case, even if a dedicated backhaul link is available, it may be preferred that it not be used for cost saving reasons. Instead, according to the invention, the dedicated backhaul link of an adjacent base station may be used instead. This may apply in situations in which it is desired to avoid maintenance or leasing costs in relation to an unnecessary backhaul link. For example, if such backhaul links have relatively little traffic over them, sending this traffic over the backhaul link of an adjacent base station may have cost advantages.

In relation to the connectivity problems discussed in the foregoing, switching over to an in-band wireless backhaul relay link and using an adjacent base station is generally a temporary measure and it is preferred that once the problem is resolved, and the dedicated backhaul link of BS A has been fully re-established, normal operation is resumed, that is operation according to FIG. 2. It is to be understood that during the period that the base station operates as a relay node it still provides access links to mobile terminals allowing them to communicate via the core network.

In a variant of the preceding embodiments of the invention, network elements may be provided with functionalities capable of performing additional actions to deal with connection problems.

In a first option, in a case in which the dedicated backhaul link of the base station BS A fails, the failure may be detected by the OAM part which then notifies the base station BS B. In order to make the establishment of the in-band wireless backhaul relay link possible, the base station BS B can re-configure itself by increasing its cell size. This is because two adjacent cells may have overlapping coverage but their area of overlap does not necessarily include the locations of the two base stations. Assuming that the base station BS A does not fall in this area of overlap, it is necessary for the base station BS B to increase the size of its cell to provide coverage which embraces the location of the base station BS A. The base station BS A can then use the radio interface of the base station BS B to establish the in-band wireless backhaul relay link. This measure can be seen to have applied in the cases of FIGS. 3 and 4. Other changes to cell coverage may be made instead of simply increasing cell size, for example using a steerable antenna to apply coverage to a particular area.

The establishment of the relay link is then done by the base station BS A as described above. This procedure can be triggered by the base station BS A recognising the base station BS B as a base station which is able to accept the base station BS A operating as a relay. The detection can be done through the radio interface by the base station BS A reading broadcast parameters of the base station BS B.

In one failure case, it is possible that the base station BS A is not aware of the fault of its dedicated backhaul and (due to the problem itself) it cannot receive an OAM originated notification about it. However, its radio interface is still useable, which means that UEs can connect to it. Therefore, if the base station BS B is aware of the problem, it can connect to the base station BS A as a regular UE and send a fault notification about the problem, indicating that the base station BS A should make a connection to the base station BS B as a relay which triggers the base station BS B to take this action.

Thus, it can be seen that the possibilities are the base station BS A detecting a problem and notifying the base station BS B of this fact, and the OAM part determining that there is a problem, notifying this to the base station BS B, the base station BS B notifying this to the base station BS A, and the base station BS A establishing an in-band wireless backhaul relay link to the base station BS B.

In a second option, there may be an already-established in-band wireless backhaul relay link between the base station BS A to the base station BS B. In the event of a communication problem, either the base station BS A can determine that the problem has occurred or can be notified of the problem by the base station BS B over the already-established link. However, since it may not be efficient for a fully-fledged in-band wireless backhaul relay link which is capable of sending user traffic to be maintained in the event that a dedicated backhaul link may fail, which would waste radio resources, an in-band wireless backhaul relay link is maintained that is useable for signaling, but has a quality/bandwidth which is not good/high enough to serve as in-band wireless backhaul relay link for user traffic. In the event that the dedicated backhaul link fails, the in-band wireless backhaul relay link can be upgraded to a fully-fledged form, that is to have a quality/bandwidth sufficient to carry all of the traffic from the base station BS A by allocating more resources to it.

It will be understood that when the air interface of a base station is utilised as an in-band wireless backhaul relay link, that part of the radio resources allocated to the relay link can be considered to be allocated to be within the transport part of the base station.

Other variants are possible. The number of temporary in-band wireless backhaul relay links which can be established by a base station changing its mode to operate as a relay node is only limited by the reachable adjacent base stations. Thus several relay links to adjacent base stations can be employed thus improving reliability and capacity. In other words, from the point of view of a relay node, or from the point of view of a base station acting as a relay, the relay node has several choices when it comes to choosing the DeNB. By selecting the best DeNB, it can be ensured that the relay link provides a good connectivity.

Determination of a problem can be made within the base station BS A, within the OAM part, or within the core network. However, in this last case, if a core network element detects a failure that has an impact on the user/management plane connection of the base station BS A, this notification is first escalated to the OAM part where it can be decided which other network elements should be notified.

The invention may be particularly useful in cases in which although a dedicated backhaul link for a base station is available, the network operator may not want to use it but rather multiplex traffic from multiple adjacent base stations to a single backhaul link for cost reasons. This approach is useful in the case of the introduction of a new radio technology. Since initially there are likely to be few users and thus little traffic, radio resources spent on the operation of an in-band wireless backhaul relay link should be available to provide connectivity in the place of dedicated backhaul links and the capacity required is likely to be low. Accordingly, it will be understood that in this configuration, a DeNB is able to receive relay-type links from a number of RNs.

In many cases a base station (to be used as an RN) is usually deployed at the edge of an adjacent cell, and a good relay link performance can be expected.

In one embodiment, the invention can be applied so that it is a function available within the self-healing framework of self-organising-(SON-) enabled base stations.

According to the invention, a network operator controlling the mobile network 200 is able to reduce loss of operator revenue, and to reduce costs which would otherwise have been incurred by employees having immediately to visit sites where failure has occurred. Furthermore, by ensuring continuity of service in the mobile network 200, this reduces the risk of churn due to user dissatisfaction.

An advantage of the present invention is that from the perspective of a mobile terminal, no change in the network layout and no service interruption will be observed, if the base station are configured to switch-over in real-time.

When operating as a relay node, a base station is also acting as a UE. In one embodiment of the invention, a base station configured to operate as a relay node may be provided with functionality corresponding to that of an embedded UE receiver. This provides a ready way of enabling the base station to carry out a UE attach operation to an adjacent base station prior to establishing a relay-type link. Furthermore, it may also be useable for other purposes, for example to enable the base station to detect radio failures in adjacent base stations, failures in its own radio interface, and carrying out diagnosis of adjacent base stations to detect sleeping cells. A base station enhanced in this way would be useful for carrying out measurements, diagnoses, and being involving in remedial action, and so could be employed by the OAM part to carry out self-healing in the context of a SON.

Although in the foregoing, the invention has been described in relation to its application in an LTE mobile communications system, it may be applied to any other advanced communication system such as a fourth generation (4G) mobile communications system. However, it should be understood that the invention is not limited to application in mobile communications systems and may be applied to communications system in which the air interface of a base station or an access point may be employed, with suitable adaptation, to provide an in-band wireless backhaul relay link.

While preferred embodiments of the invention have been shown and described, it will be understood that such embodiments are described by way of example only. Numerous variations, changes and substitutions will occur to those skilled in the art without departing from the scope of the present invention. Accordingly, it is intended that the following claims cover all such variations or equivalents as fall within the spirit and the scope of the invention.

1. A method of establishing a relay connection between a relay node and a neighbouring base station, comprising the steps of:
activating relay capability of a base station so that it operates as a relay node; and
establishing an in-band wireless backhaul relay link between the base station operating as a relay node and the neighbouring base station.

2. A method according to claim 1 in which a determination is made that an in-band wireless backhaul relay link is to be used.

3. A method according to claim 2 in which the determination is made within at least one of: the base station capable of operating as a relay node; a neighbouring base station; a core network; and an OAM part.

4. A method according to claim 3 in which, in the case in which the determination is made in the OAM part, the OAM part provides a notification to the base station capable of operating as a relay node via the neighbouring base station that it is to establish the in-band wireless backhaul relay link with the neighbouring base station.

5. A method according to claim 2 in which the determination is made following the detection of a communication problem.

6. A method according to claim 5 in which the communication problem causes disruption only to one of a user data connection and a OAM data connection and one of these connections is routed via the in-band wireless backhaul relay link to the neighbouring base station and then via a backhaul link between that base station, and the other of these connections is routed via the backhaul link of the base station capable of operating as a relay node.

7. A method according to claim 1 in which the base station capable of operating as a relay node is pre-configured to enable an in-band wireless backhaul relay link to be used during a network installation/rollout.

8. A method according to claim 1 in which at least one of the neighbouring base station and the base station capable of operating as a relay node is able to modify its cell coverage to cover the location of the other base station.

9. A method according to claim 1 in which the base station capable of operating as a relay node is pre-configured with information about a particular neighbouring base station through which it can connect to via the in-band wireless backhaul relay link.

10. A method according to claim 1 in which the base station capable of operating as a relay node uses a cell selection procedure to select a neighbouring base station which appears to offer the best connectivity for the in-band wireless backhaul relay link.

11. A method according to claim 1 in which the neighbouring base station is used to multiplex traffic from multiple base stations capable of operating as relay nodes to a single backhaul link.

12. A method according to claim 1 in which the base station has a dual-operation mode in which it is concurrently operating as a relay node and as a base station.

13. A method according to claim 1 in which the in-band wireless backhaul relay link is useable for signaling but has a quality and/or bandwidth which is not good and/or high enough to serve as an in-band wireless backhaul relay link for user traffic and a notification received by the base station capable of operating as a relay node causes it to re-configure itself to improve the characteristics of the in-band wireless backhaul relay link so that it is able to serve as in-band wireless backhaul relay link for user traffic.

14. A base station comprising:
a relay capability which enables the base station to operate as a relay node; and
a connectivity element capable of establishing an in-band wireless backhaul relay link a between the base station operating as a relay node and a neighbouring base station.

15. A communication system comprising an access network having a plurality of base stations where at least one base station comprises:
a relay capability which enables the base station to operate as a relay node; and
a connectivity element capable of establishing an in-band wireless backhaul relay link a between the base station operating as a relay node and a neighbouring base station.
